(19) United States
(12) Patent Application Publication
(10) Pub. No.: US 2010/0029867 A1
(43) Pub. Date: Feb. 4, 2010

(54) GAS PHASE POLYMERIZATION APPARATUS AND METHOD FOR PRODUCING OLEFIN POLYMER

(75) Inventors: Shinichi TAKAHASHI, Shizuoka-shi (JP); Ryota SASAKI, Chiba-shi (JP); Hajime KOBAYASHI, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/511,229

(22) Filed: Jul. 29, 2009

(30) Foreign Application Priority Data
Aug. 1, 2008 (JP) 2008/199943

(51) Int. Cl. C08F 2/01; B01J 19/00

(52) U.S. Cl. 526/88; 422/131

(57) ABSTRACT

A gas phase polymerization apparatus 100 of the present invention is configured so as to include: a gas phase polymerization reactor 1; a gas separator 110 into which a mixture of a polymer powder and a gas is introduced; and a transfer tube 3 connecting the polymerization reactor 100 and the separator 110, the separator 110 including: an inlet port 2a through which the mixture is introduced; a replacement gas inlet 4a through which a replacement gas is introduced; an outlet port 2b through which the polymer powder is discharged; and a tank 2 in which the gas contained in the mixture is replaced with the replacement gas, the tank 2 being a columnar tank having one end section which is configured in a conical shape whose cross sectional area decreases toward a tip of the section, and the outlet port 2b being provided at the tip of the conically-shaped section of the tank 2.

This Nonprovisional application claims priority under 35 U.S.C. §119(a) on Patent Application No. 2008-199943 filed in Japan on Aug. 1, 2008, the entire contents of which are hereby incorporated by reference.

### TECHNICAL FIELD

The present invention relates to gas phase polymerization apparatuses and methods for producing an olefin polymer by using the gas phase polymerization apparatuses.

### BACKGROUND ART

Conventionally, gas phase polymerization apparatuses are commonly used in producing polyolefins such as polypropylene and polyethylene. There is known a method for producing a desired polymer by using a gas phase polymerization apparatus which includes a plurality of polymerization reactors connected to each another and varying the gas compositions in the reactors.

For example, Patent Document 1 (JP 2000-344804 A (Publication Date: Dec. 12, 2000)) discloses a multistage gas phase polymerization method using at least two fluidized bed reactors continuously together, wherein a polymer powder produced in a reactor disposed upstream is discharged from the reactor and, when the polymer powder is introduced into a reactor disposed downstream, the amounts of auxiliary materials (α-olefin and a hydrogen gas) accompanying the polymer powder are reduced. Patent Document 1 further discloses (i) a device for reducing the amounts of auxiliary materials accompanying the polymer powder and (ii) a multistage gas phase polymerization apparatus using this device.

The device for reducing the amounts of auxiliary materials includes a weight valve, a separator, and a rotary valve, and the separator is provided with a purge gas supply line and a purge gas discharge line. The weight valve is a device for transferring a given amount of the polymer powder into the separator, and the rotary valve is a device for discharging a powder component in a given amount.

On the other hand, Patent Document 2 (JP 2006-52387 A (Publication Date: Feb. 23, 2006)) discloses: a polymerization apparatus which can be operated continuously and can replace a gas by another gas in an arbitrary ratio; and a polymerization method using the apparatus.

FIG. 4 is a diagram schematically showing the configuration of a conventional polymerization apparatus 200 that is disclosed in the Patent Document 2. As shown in FIG. 4, the apparatus 200 includes: a gas replacement tank 22; and a gas phase polymerization reactor 21 provided upstream from the gas replacement tank 22. The gas replacement tank 22 is divided into an upper chamber and a lower chamber by a gas distribution plate 23, and a replacement gas introduction port 24 is provided below the gas distribution plate 23. A replacement gas supplied through the replacement gas introduction port 24 passes through the gas distribution plate 23, so that it is supplied uniformly into the upper chamber.

In the upper chamber located above the gas distribution plate 23, reception of a polymer powder supplied from the upstream gas phase polymerization reactor 21 and extraction of the polymer powder toward the downstream gas phase polymerization reactor 26 are carried out. In the upper chamber above the gas distribution plate 23, a part or the whole of the gas which accompanies the polymer powder is replaced with the replacement gas supplied to above the gas distribution plate 23.

When the apparatus disclosed in the Patent Document 1 is used as described above, a polymer powder may stay at the weight valve or the rotary valve, and also the staying polymer powder may polymerize to form a mass. Such stay of a polymer powder may occur also in the separator depending on the configuration of the separator. Therefore, clogging may occur in the separator.

In the apparatus disclosed in the Patent Document 1, a discharged purge gas must be returned to the fluidized bed through an additional discharge line. As such, when the discharged purge gas is used for another purpose, the discharged purge gas must be collected.

The polymerization apparatus 200 disclosed in the Patent Document 2 includes a gas replacement tank 22 for separating an auxiliary material gas accompanying a polymer powder, the tank 22 being provided between the upstream gas phase polymerization reactor 21 and the downstream gas phase polymerization reactor 26. The reactor 21, the tank 22, and the reactor 26 are provided tandem. As shown in FIG. 4, in the polymerization apparatus 200, the gas replacement tank 22 has a side wall which is provided with a discharge port 25 for a polymer powder. Therefore, a polymer powder may not be completely discharged and a part of the powder may stay. In addition, the staying polymer powder may further polymerize to form a mass in the gas replacement tank 22. Therefore, clogging of the discharge port may occur, resulting in difficulty in operating the apparatus continuously for a long time period.

### SUMMARY OF INVENTION

The present invention is made in view of the problem with such conventional technologies, and an object of the present invention is to provide a gas phase polymerization apparatus: that is advantageous in that (i) a polymer powder hardly stays, so that the powder can be easily collected from the apparatus; (ii) since a polymer powder hardly forms a mass, clogging of a discharge port hardly occurs and therefore the apparatus can be operated continuously for a long time period; the apparatus need not be provided with means specially designed for discharging a gas accompanying a polymer powder.

The gas phase polymerization apparatus of the present invention is configured to include: a gas phase polymerization reactor; a gas separator into which a mixture of a polymer powder and a gas is introduced; and a transfer tube connecting the reactor and the separator, the separator having: an inlet port through which the mixture is introduced; a replacement gas inlet through which a replacement gas is introduced; an outlet port through which the polymer powder is discharged; and a tank in which the gas contained in the mixture is replaced with the replacement gas. The tank has a columnar shape having one end section which is configured in a conical shape whose cross sectional area decreases toward the tip of the section, and the outlet port is provided at the tip of the conically-shaped section.

The gas phase polymerization apparatus of the present invention includes: a gas phase polymerization reactor; a gas separator; and a transfer tube connecting the reactor and the separator. Therefore, when a gas that accompanies a polymer powder produced in the reactor is removed from the polymer powder in the gas separator, the removed gas can return to the reactor through the transfer tube. As such, the gas phase polymerization apparatus need not be provided with a device for recycling the removed gas. Further, the gas phase polymerization apparatus does not need to discharge the removed gas by discharge means.

Further, the gas separator includes a columnar tank in which from a mixture of a polymer powder and an accompanying gas, the accompanying gas is replaced with a replacement gas. Since the tank has one end configured in a conical shape, a polymer powder can flow down along the inner wall of the conically-shaped section of the tank when the polymer powder is discharged through the outlet port. Thus, the polymer powder can be easily collected through the outlet port provided at the tip of the conically-shaped section of the tank. That is, it is possible to inhibit a polymer powder from staying near the outlet port and prevent the outlet port from clogging with the polymer powder.

In the gas phase polymerization apparatus of the present invention, it is desirable that the transfer tube be always opened. This makes it possible to return the accompanying gas that has been replaced with a replacement gas in the gas separator to the polymerization reactor to reuse it.

In the gas phase polymerization apparatus of the present invention, when the longitudinal direction of the tank of the gas separator coincides with the vertical direction, it is desirable that a relationship represented by the following formula (1) be satisfied: θᵣ≦S₁≦90° (1), where S₁ is the degree of the angle formed between (i) a slope of the conically-shaped section of the tank and (ii) the horizontal plane, and Or is the degree of the angle of repose of the polymer powder introduced into the gas separator.

The tank is conically shaped at its end section where the outlet port is provided. When the longitudinal direction of the tank coincides with the vertical direction, the degree of the angle formed between the slope of the conically-shaped section of the tank and the horizontal plane has a size, S₁, which satisfies the formula (1). When the polymer powder reaches the inner wall of the conically-shaped section of the tank, the polymer powder moves toward the outlet port without staying there. In other words, the polymer powder smoothly falls along the inner wall. Thus, the polymer powder can be distinguished easily from the tank.

In the gas phase polymerization apparatus of the present invention, it is preferable that when the longitudinal direction of the tank of the gas separator coincides with the vertical direction, S₁, which is the degree of the angle formed between (i) a slope of the conically-shaped section of the tank and (ii) the horizontal plane be within the range of from 30° (inclusive) to 90° (exclusive).

If the S₁ is in the above range, a polymer powder can smoothly flow down toward the outlet port when the polymer powder reaches the inner wall of the conically-shaped section of the tank. Thus, it is easy to discharge the polymer powder from the tank.

In accordance with one embodiment of the gas phase polymerization apparatus of the present invention, when the longitudinal direction of the tank of the gas separator coincides with the vertical direction, the transfer tube is connected to the vertical side wall of the polymerization reactor at its one end and to the gas separator at the other end. It is preferable that a relationship 0°≦S₂≦90° (2) be satisfied, where S₂ is the degree of the angle formed between (a) a straight line that is tangential to the inner wall surface of the transfer tube and passes the lowermost point of the connection section of the transfer tube and the vertical side wall, and (b) a plane orthogonal to the surface of the vertical side wall; and that a relationship θᵣ≦S₃≦90° (3) be satisfied, where S₃ is the degree of the angle formed between (c) a straight line that is tangential to the inner wall surface of the transfer tube at the lowest tangential point and that passes the uppermost point of the connection section and (d) the plane orthogonal to the surface of the vertical side wall.

With the foregoing configuration, because the transfer tube is fixed to the gas phase polymerization reactor so that the formulas (2) and (3) may be satisfied, it is unnecessary to control the pressure when transferring a polymer powder from the polymerization reactor, and the polymer powder flows down toward the tank only by the action of gravity. Thus, it is easy to transfer the polymer powder from the polymerization reactor to the tank.

The method in accordance with the present invention for producing an olefin polymer is a method using the gas phase polymerization apparatus of the present invention which includes a polymerization reactor, a gas separator, and a transfer tube connecting the reactor and the separator, the method including: a polymerization step of polymerizing an olefin in the reactor in the presence of a first gas containing the olefin to produce a powder of a polymer of the olefin; a transfer step of transferring, from the reactor into the separator through the transfer tube, a mixture of (a) the polymer powder and (b) a second gas which coexists with the polymer powder in the reactor; a separation step of supplying a third gas into the separator so as to replace, with the third gas, at least a part of the second gas contained in the mixture transferred into the separator through the transfer step, thereby separating at least a part of the second gas from the polymer powder; and a discharge step of discharging the polymer powder through the outlet port of the separator after the separation step.

According to the foregoing configuration, the polymer powder can be discharged through the outlet port without staying near the outlet port during the discharge step. This makes it possible to produce an olefin polymer continuously for a long time.

According to the method of the present invention, at least a part of the second gas that accompanies the polymer powder introduced into the separator is replaced with the third gas so as to be separated from the polymer powder. As such, when a gas phase polymerization apparatus including a plurality of polymerization reactors which are serially aligned is used in the execution of the method of the present invention, a polymer powder resulting from the separation of at least a part of the second gas is transferred into a downstream polymerization reactor. This allows, in polymerization reaction to be carried out in the downstream polymerization reactor, use of a polymer powder less influential to the polymerization reaction. Thus, it is possible to control the physical properties of the produced polymer.

In the polymerization method of the present invention, it is preferable, in the discharge step, to discharge the polymer powder through the outlet port by opening the outlet port intermittently.

According to the foregoing configuration, by accumulating a mixture of a polymer powder and an accompanying gas in the gas separator for a certain period of time, it is possible to replace the accompanying gas in the mixture efficiently. Furthermore, by opening the outlet port intermittently, it is possible to perform a polymerization reaction without lowering the pressure in the polymerization reactor that is provided upstream from and is directly connected to the separator.

Moreover, in the method of the present invention, it is more desirable that the second gas separated from the mixture through the separation step be transferred into the polymerization reactor through the transfer tube.

With the foregoing configuration, it is unnecessary for the apparatus to be equipped with a device for recycling the second gas that has been removed from the mixture of the polymer powder and the second gas in the gas separator. Further, it is also unnecessary to discharge the removed second gas from a system by discharge means or the like.

### BRIEF DESCRIPTION OF DRAWINGS

FIG. 1 is a diagram schematically showing the configuration of a gas separator in accordance with one embodiment of the present invention.

FIG. 2 is a diagram schematically showing the configuration of a gas phase polymerization apparatus in accordance with one embodiment of the present invention.

FIG. 3 is an elevation view schematically showing the configuration of a transfer tube.

FIG. 4 is a diagram schematically showing the configuration of a conventional gas phase polymerization apparatus.

### DESCRIPTION OF EMBODIMENTS

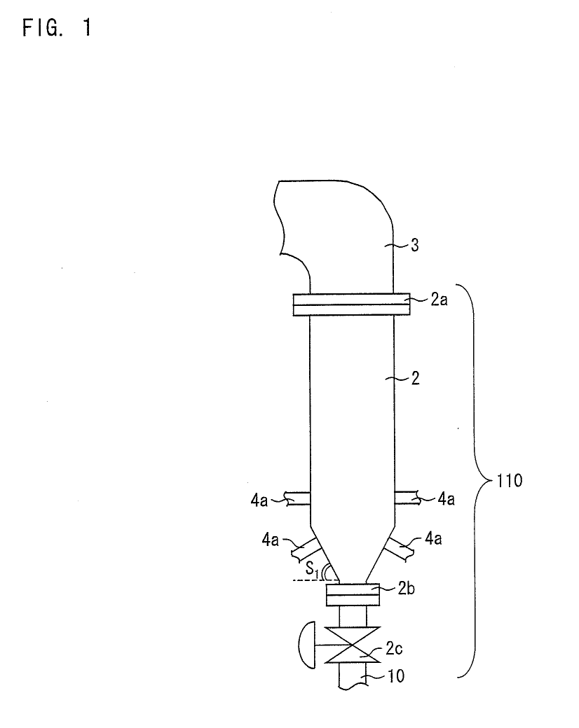

One embodiment of the present invention is described below with reference to FIGS. 1 through 3.

(Configuration of Gas Phase Polymerization Apparatus 100)

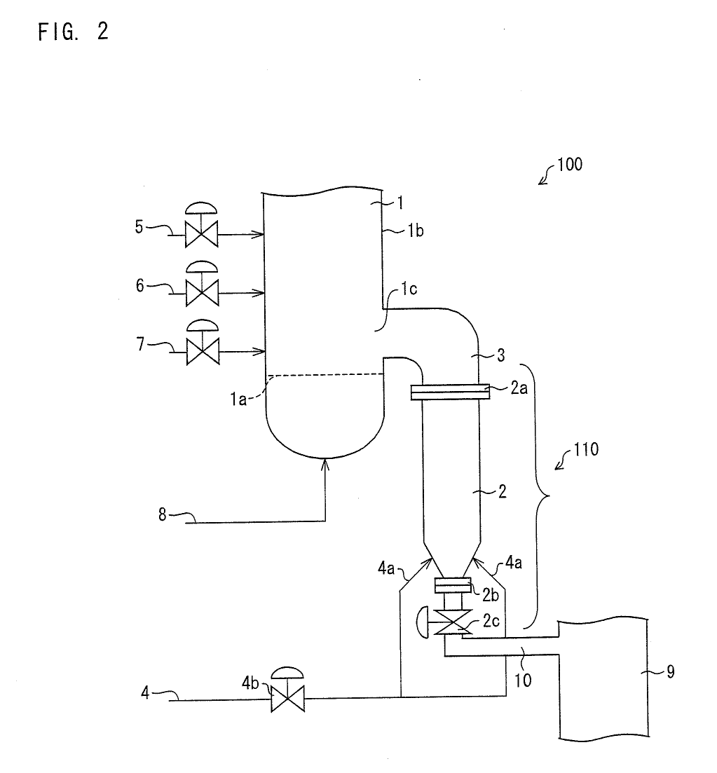

FIG. 2 is a diagram schematically showing the configuration of a gas phase polymerization apparatus 100 in accordance with present embodiment.

The gas phase polymerization apparatus 100 includes: a gas phase polymerization reactor 1; a gas separator 110; a transfer tube 3; and a downstream polymerization reactor 9.

The gas phase polymerization reactor 1 includes: a catalyst supply line 5; an olefin supply line 6; an auxiliary material supply line 7; a gas distribution plate 1a; and a circulating gas supply line 8.

The gas phase polymerization reactor 1 is a reactor in which an olefin is polymerized in the presence of a catalyst and an auxiliary material, such as hydrogen, so as to produce a polymer powder of an olefin polymer (which may be simply referred to as “polymer powder” hereinafter). The configuration of reactor 1 will be described in detail later.

The gas separator 110 includes: a separation tank 2; an inlet port 2a; an outlet port 2b; a discharge control valve 2c; a replacement gas supply line 4; a replacement gas supply nozzle 4a; and a replacement gas supply control valve 4b.

The gas separator 110 is a device for separating, from a mixture of a polymer powder and an accompanying gas introduced from the gas phase polymerization reactor 1, the accompanying gas by replacing the accompanying gas with a replacement gas, which is described later. The accompanying gas contains an unreacted olefin gas, an auxiliary material gas, such as hydrogen, and the like. The configuration of the separator 110 will be described in detail with reference to FIG. 1 later.

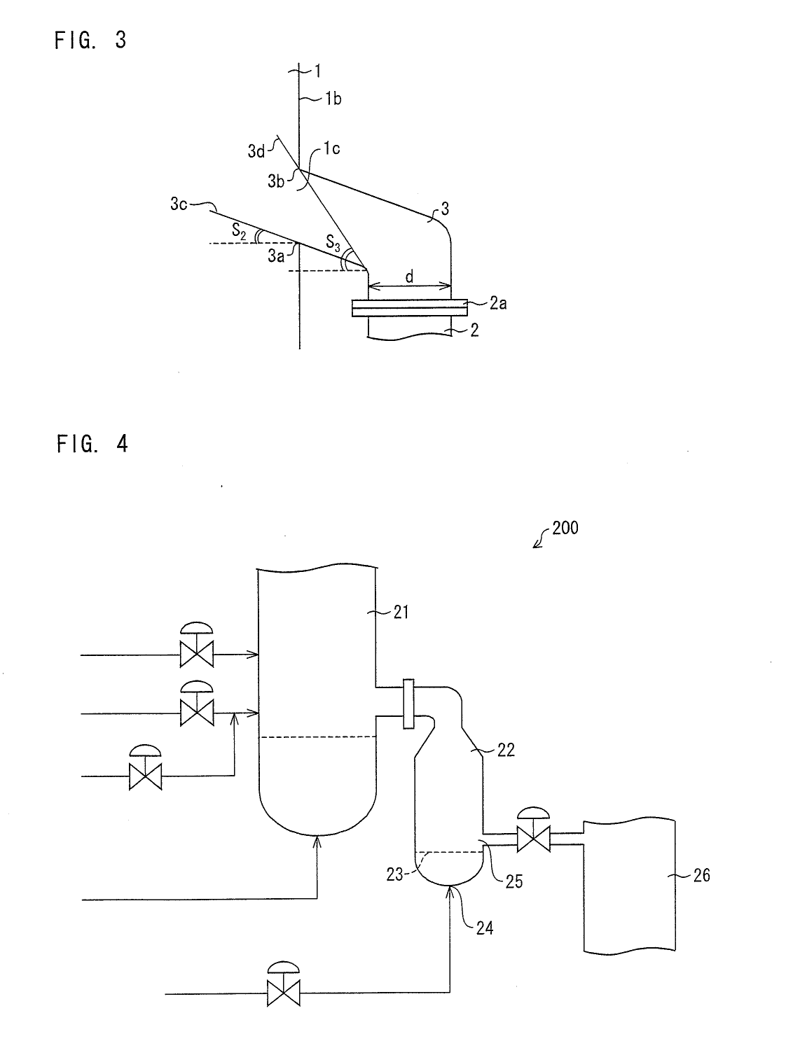

The transfer tube 3 functions as a transfer tube through which the polymer powder is transferred, and it connects the reactor 1 and the separator 110. Thus, the polymer powder produced in the reactor 1 is transferred to the separator 110 through the transfer tube 3. The configuration of the transfer tube 3 will be described in detail with reference to FIG. 3 later.

In the present embodiment, the gas phase polymerization apparatus 100 includes a downstream gas phase polymerization reactor 9. The downstream reactor 9 is a reactor for polymerizing, to an olefin polymer having been produced in the reactor 1, an olefin having a different property or an olefin of a different kind.

The downstream gas phase polymerization reactor 9 is connected to an outlet port 2b of the gas separator 110 through the transfer tube 10. The transfer tube 10 is provided with a discharge control valve 2c. The amount of the polymer powder to be discharged through the outlet port 2b is controlled with a discharge control valve 2c. The polymer powder separated from the accompanying gas is discharged intermittently into the reactor 9 by utilizing the pressure difference between the separation tank 2 and the reactor 9 by opening and closing of the valve 2c.

The downstream gas phase polymerization reactor 9 may be a conventionally known polymerization reactor, and may be configured in the same manner as the polymerization reactor 1 of the present embodiment.

(Configuration of Gas Phase Polymerization Reactor 1)

Next, the configuration of the gas phase polymerization reactor 1 is described in detail with reference to FIG. 2.

The reactor 1 includes: the catalyst supply line 5; the olefin supply line 6; the auxiliary material supply line 7; the gas distribution plate la; and the circulating gas supply line 8. Further, a vertical side wall lb of the reactor 1 is provided with a transfer nozzle 1c for connecting the polymerization tank 1 and the transfer tube 3.

The reactor 1 may be configured in such a manner that polymerization reaction can be carried out therein. It may be, for example, a fluidized-bed type gas phase polymerization reactor. In a fluidized-bed type gas phase polymerization reactor, the polymerization reaction is advanced as a polymer powder is fluidized in the reactor so as to form a fluidized layer. In particular, at first, a gas which contains an olefin monomer is introduced from beneath the gas distribution plate la through the circulating gas supply line 8, and uniformly distributed. Subsequently, the uniformly distributed gas rises up in the reactor 1 as fluidizing the polymer powder which has been produced by the polymerization reaction or powders of a catalyst or the like. The polymer powder thus fluidized constitutes a fluidized layer. In the fluidized layer, gaseous monomers come into contact with the powder of the catalyst or the like, so that a polymerization reaction proceeds to produce a powdery polymer. The thickness of the fluidized layer may be determined appropriately based on factors such as a gas flow rate and properties of the polymer powder.

The olefin supply line 6 functions as means for supplying an olefin, which is the main raw material (monomer) of a polymer to be synthesized in the present invention. The line 6 is connected to the side wall of the reactor 1, and the olefin is introduced into the reactor 1 through the line 6.

The olefin may be a polymerizable olefin, and examples of such olefin include C₂ to C₁₀ olefins. Among them, C₂ to C₈ olefins are preferable, and examples of such olefins include ethylene and propylene. Either a single kind of olefin or two or more kinds of olefins may be supplied to the reactor 1. An example of a combination of two or more kinds of olefins includes a combination of ethylene and one or more kinds of C₃ to C₁₀ olefins. Among them, a mixture of ethylene and one or more kinds of C₃ to C₈ olefins (e.g., propylene, 1-butene, 1-hexene, 4-methyl-1-pentene, and 1-octene) is more preferable.

The olefin to be supplied into the reactor 1 through the olefin supply line 6 may be in a state that the olefin can be introduced into the reactor 1 and can polymerize to produce a polymer. For example, because a fluidized layer can be easily formed, it is preferable that the olefin be supplied in a gaseous form.

The catalyst supply line 5 functions as means for supplying a catalyst for use in a polymerization reaction. The catalyst supply line 5 is connected to the side wall of the reactor 1, and the catalyst is introduced into the reactor 1 through the catalyst supply line 5.

Examples of the catalyst include metallocene catalyst and Ziegler-Natta catalyst.

The auxiliary material supply line 7 functions as means for supplying auxiliary materials for use in the polymerization reaction. The auxiliary supply line 7 is connected to the side wall of the reactor 1, and auxiliary materials are introduced into the reactor 1 through the auxiliary material supply line 7.

Auxiliary materials are materials that are added in accordance with necessity. Examples of such auxiliary materials include: molecular weight modifiers, such as hydrogen gas, and inert gases, such as a nitrogen gas.

Although the olefin supply line 6 and the auxiliary material supply line 7 are connected to the side wall of the reactor 1 in the embodiment shown in FIG. 2, the lines 6 and 7 may be connected to the circulating gas supply line 8.

The gas distribution plate la is a device with which a circulating gas supplied into the reactor 1 is distributed uniformly into the reactor 1.

The gas distribution plate la may be a gas distribution plate which allows the supplied gas to pass through while not allowing the produced polymer powder to pass. It is preferable that the gas distribution plate la be in such a shape that a fluidized state of the fluidized layer is well maintained by a flow of the circulating gas.

A remaining gas that has not been consumed in the polymerization reaction in the reactor 1, including an unreacted olefin gas and auxiliary material gas, is discharged through a gas discharge outlet (not shown) of the reactor 1, returned to the circulating gas supply line 8, and supplied again to the fluidized layer in the reactor 1. The line 8 may be connected to the reactor 1 at a position below the gas distribution plate 1a.

The transfer nozzle 1c is provided to the vertical side wall 1b for transferring, into the transfer tube 3, a polymer powder produced in the reactor 1. The nozzle 1c connects the reactor 1 and the transfer tube 3, while being kept open. This causes the reactor 1 to be opened always to the transfer tube 3.

(Configuration of Gas Separator 110)

FIG. 1 is a diagram schematically showing the configuration of a gas separator 110.

The separator 110 includes: a separation tank 2; an inlet port 2a; an outlet port 2b; a transfer control valve 2c; a replacement gas supply line 4; a replacement gas supply nozzle 4a; and a replacement gas supply control valve 4b.

The separation tank 2 is a tank for replacing an accompanying gas contained in a mixture transferred from the gas phase polymerization reactor 1 with a replacement gas, and it has a columnar structure having one end in a conical shape. The outlet port 2b may be provided at the tip of the conically-shaped section of the tank 2.

The accompanying gas has the same composition as the gas for use in the polymerization reaction in the gas phase polymerization reactor 1, and contains the olefin gas (the main raw material). The accompanying gas may contain an inert gas, such as nitrogen gas and saturated hydrocarbon gas, and an auxiliary material gas, such as hydrogen gas.

The separation tank 2 has a columnar part, which is generally a hollow cylinder whose inner diameter may be either greater or smaller than that of the transfer tube 3 connecting the reactor 1 and the separation tank 2. For example, as in the present embodiment, the separation tank 2 may have a columnar part whose inner diameter is equal to that of the transfer tube 3.

The separation tank 2 of the present embodiment has one end section (an end section to which the outlet port 2b is provided) which is configured in a conical shape whose cross sectional area decreases toward the tip of the end section. That is, the separation tank 2 has a conically-shaped structure whose cross sectional area decreases downwardly when the separation tank 2 is disposed so that the longitudinal direction of the tank 2 will coincide with the vertical direction.

The term “conical shape” or “conically-shaped” as used herein should not be considered as relating only to shapes with circular cross sections, but should be construed to also include pyramidal shapes with polygonal sections. Examples of the conical shape include symmetric cones and symmetric pyramids. However, it is not necessary that a conical shape be symmetric. When the separation tank 2 has one end configured in such a shape, a polymer powder from which an accompanying gas has been separated hardly stays near the outlet port 2b when the powder is discharged from the tank.

S₁ in FIG. 1 represents the degree of the angle which is formed between (i) a slope of the conically-shaped section of the separation tank 2 and (ii) a horizontal plane when the separation tank 2 of the gas separator apparatus 110 is disposed so that the longitudinal direction of the tank 2 may coincide with the vertical direction. The degree S₁ of the angle may satisfy the following formula (1)

θᵣ≦S₁<90° (1)

where θᵣ is the degree of an angle of repose of the polymer powder introduced into the separation tank 2. Further, unless otherwise noted, the following explains a case that the gas separator 110 is disposed so that the longitudinal direction of the separation tank 2 of the separator 110 will coincide with the vertical direction.

The angle of repose is an angle to be formed between a generatrix and a bottom surface when a powder is continuously poured onto a horizontal plane by use of a funnel, an orifice, or the like so as to form a conical pile (* refer to D. F. Othmer and F. A. Zenz, “Fluidization and Fluid-Particle System” pp 85-88, Reinhold Chemical Engineering Series, New York, Reinhold publishing company (1960)). The degree of the angle of repose can be worked out by a conventionally known method, such as an injection method, a discharge method, and a tilting method.

When (i) the slope of the conically-shaped section of the separation tank 2 of the present invention and (ii) the horizontal plane forms the angle whose degree S₁ is greater or equal to that of the angle of repose of the produced polymer powder, smoother falling of the polymer powder into the outlet port 2b can be achieved. It is more preferable that the degree S₁ of the angle be in a range of from 30° (inclusive) to 90° (exclusive). This allows further smoother falling of the polymer powder into the outlet port 2b.

For example, in a configuration which connects the outlet port 2b with the downstream reactor 9 (which is the downstream one of the polymerization reactors), when the discharge control valve 2c is opened, the polymer powder near the outlet port 2b of the separation tank 2 is transferred due to the pressure difference between the separation tank 2 and the downstream reactor 9. In this case, if the degree S1 of the angle is greater than or equal to that of the angle of repose of the polymer powder, it is then possible to cause the polymer powder to smoothly fall into the outlet port 2b, and it thereby is possible to inhibit the polymer powder from forming a mass near the outlet port 2b. If the polymer powder forms a mass in such a manner, this will cause clogging of the outlet port 2b. In order to prevent generation of the clogging or to remove the clogging, it is necessary to make some measure. For example, the operation of the apparatus must be stopped so as to clean the apparatus. According to the present invention, it is possible to prevent the clogging from occurring without taking such a measure.

The degree of the angle of repose varies depending on the kind of the polymer powder to be produced. For example, when the degree of the angle of repose of a polymer powder is measured by an injection method, the degree ranges of the angle of repose of typical polyolefin powders are 20° to 35° for polypropylene; 20° to 40° for ethylene-propylene block copolymer powder; 20° to 35° for ethylene-propylene random copolymer powder; and 25° to 40° for polyethylene powder.

The capacity of the separation tank 2 is preferably, for example, equal to or greater than the apparent volume of the polymer powder which is to be transferred into the downstream gas phase polymerization reactor 9. The apparent volume is a sum total of the actual volume of the polymer powder and the volume of the accompanying gas present in the polymer powder. When intermittent transferring of the polymer powder into the downstream reactor 9 is carried out, the apparent volume of the polymer powder to be transferred is an apparent volume of the polymer powder transferred by one intermittent transferring. The fact that the separation tank 2 has a capacity that is equal to greater than the apparent volume of the polymer powder results in the following advantages.

When the distance between the inlet port 2a and the outlet port 2b of the separation tank 2 is short, for example, the accompanying gas may directly flow into the transfer tube 10 which connects the separation tank 2 and the downstream reactor 9. When the time during which the polymer powder and the replacement gas are in contact with each other is short, the accompanying gas in the polymer powder is replaced insufficiently, and, as a result, the amount of the accompanying gas that accompanies the polymer powder which is introduced into the downstream reactor 9 increases. Therefore, use of the separation tank 2 having a capacity that is equal to or greater than the apparent volume of the polymer powder allows sufficient contact between the accompanying gas and the replacement gas and, as a result, makes it possible to inhibit the accompanying gas from flowing into the downstream reactor 9.

The inlet port 2a functions as an inlet through which the powder produced in the reactor 1 is introduced into the separation tank 2. The powder to be introduced through the inlet port 2a is composed of powdery particles of an olefin polymer (polyolefin). The powder is accompanied by a gas which was introduced into the reactor 1 when the polymerization reaction was performed.

As such, a replacement gas supply nozzle 4a is provided to the separation tank 2 in the present embodiment so as to remove the accompanying gas from the polymer powder.

The replacement gas supply nozzle 4a is a nozzle through which a gas for separating the accompanying gas from the polymer powder is introduced from the replacement gas supply line 4. It is preferable that a plurality of replacement gas supply nozzles 4a be provided to the separation tank 2. In the present embodiment, the replacement gas supply nozzles 4a are provided at four points as shown in FIG. 1.

When a plurality of the replacement gas supply nozzles 4a are provided, it is preferable that the nozzles 4a be provided at fixed intervals. Providing of the nozzles 4a at fixed intervals makes it possible to cause the replacement gas supplied through the nozzles 4a to flow uniformly into the separation tank 2. Because this allows (i) a mixture of the polymer and the accompanying gas having been introduced into the removal tank 2 and (ii) the replacement gas to come into contact uniformly with each other, it is possible to replace the accompanying gas with the replacement gas efficiently.

The replacement gas supply nozzles 4a may be connected to the separation tank 2 in (i) a configuration that the replacement gas supply nozzles 4a are provided tangentially to the inner wall surface of the tank 2 in such a manner that the replacement gas can circulate along the inner wall of the tank 2 or (ii) a configuration that the replacement gas supply nozzles 4a are provided orthogonally to the inner wall surface of the tank 2. It is possible to perform gas replacement efficiently in either of the configurations illustrated herein.

The replacement gas supply nozzle 4a may further have, at the tip portion of the supply port through which a replacement gas is supplied, a mechanism designed so as to successfully prevent a polymer powder from entering the nozzle. Examples of such a configuration include a porous plate and a mesh.

The replacement gas described above is a gas for separating the accompanying gas from the polymer powder. Thus, the accompanying gas that has accompanied the polymer powder is replaced with the replacement gas. Such a replacement gas may be a gas which is capable of separating the accompanying gas and which does not interfere with the polymerization reaction of a later stage. Examples of the replacement gas include an olefin gas that is to be used as a raw material for the polymerization reaction of the later stage.

The replacement gas supply control valve 4b functions as means for controlling the supply amount of the replacement gas. The valve 4b is provided in the replacement gas supply line 4, and this can control the supply amount of the replacement gas through opening and closing of the valve 4b.

It is preferable that the supply amount of the replacement gas be in an amount as much as the accompanying gas contained in the polymer powder discharged from the separation tank 2 is replaced to an amount as small as no influence is given to the polymerization reaction performed in the downstream reactor 9.

Generally, the amount of the accompanying gas of the polymer powder discharged from the separation tank 2 is proportional to the weight of the polymer powder discharged through the outlet port 2b. The amount of the accompanying gas of the polymer powder may depend on the kind of the polymer powder or that of the accompanying gas. Further, it may also depend on such factors as (i) the pressure difference between the separation tank 2 and the downstream reactor 9 or (ii) the diameter or the length of the transfer tube 10 connecting the separation tank 2 and the downstream reactor 9. In view of this, it is possible to control the replacement rate of the accompanying gas by adjusting the amount of the replacement gas to be introduced relative to the amount of the accompanying gas.

Furthermore, when a gas of an olefin that is of the same type as that of the olefin supplied into the gas phase polymerization reactor 1 through the olefin supply line 6 is used as the replacement gas, it is preferable that the sum total of (i) the supply amount of the replacement gas and (ii) the amount of the gas of the olefin supplied into the reactor 1 through the olefin supply line 6 be not greater than the amount of the olefin gas consumed in the reactor 1.

The outlet port 2b is provided for discharging a polymer powder from which an accompanying gas has been separated. The amount of the polymer powder discharged through the outlet port 2b is controlled with the discharge control valve 2c. The polymer powder from which the accompanying gas has been separated is discharged through the outlet port 2b, and then is transferred into a downstream gas phase polymerization reactor 9, which is a later stage reactor. It is to be noted that the present invention includes an embodiment that a polymer powder discharged through the outlet port 2b is produced as a final product without being transferred into the downstream reactor 9.

(Configuration of Transfer Tube 3)

FIG. 3 is a diagram schematically showing the configuration of the transfer tube.

The transfer tube 3 is connected to the vertical side wall 1b of the reactor 1 while being open and also is connected to the inlet port 2a of the gas separator 110. S₂ shown in FIG. 3 is the degree of an angle formed, at a point 3a, between (i) a gradient line 3c of an inside bottom section of the transfer tube 3 and (ii) a horizontal plane, wherein the angle is formed when the longitudinal direction of the separation tank 2 coincides with the vertical direction. It is to be noted that the point 3a is the lowest point of the joint of the transfer tube 3 and the vertical side wall 1b, and that the horizontal plane is a plane perpendicular to the wall surface of the vertical side wall 1b. When the transfer tube 3 connected to the vertical side wall 1b of the reactor 1 has an inside bottom section that extends along a straight line, the gradient line 3c is a straight line parallel to the longitudinal direction of the inside bottom section of the transfer tube 3. On the other hand, when the transfer tube 3 connected to the vertical side wall lb of the reactor 1 has an inside bottom section that extends along a curved line, the gradient 3c is a tangent obtained at a point where the curved line is in contact with the point 3a. Thus, the gradient line 3c can be said as a straight line (i) which is tangential to the inner wall surface of the transfer tube 3, and (ii) which passes through the point 3a.

S₃ shown in FIG. 3 is the degree of an angle formed between the tangent 3d and a horizontal plane, wherein the angle is formed when the longitudinal direction of the separation tank 2 coincides with the vertical direction. It is to be noted that the tangent 3d is a line which passes through (i) a point on an inside bottom surface of the downwardly-bent or -curved transfer tube 3 and (ii) a point 3b at an upper end of the connection section of the downwardly-bent or -curved transfer tube 3 and the vertical side wall 1b. Thus, the tangent 3d can be said as a straight line tangential to the inner wall surface of the transfer tube 3, the tangent 3d passing though the point 3b and crossing the transfer tube 3 at the point lower than others.

It is more preferable that a potential range of S₂ be a range which satisfies the following formula (2), whereas a potential range of S₃ be an range which satisfies the following formula (3).

0°≦S₂≦90° (2)

θᵣ≦S₃≦90° (3)

If the degrees of angles S₂ and S₃ are within such ranges, when the polymer powder is transferred from the reactor 1 into the separation tank 2 through the transfer tube 3, the polymer powder can be flown into the transfer tube 3 smoothly by the action of gravity without application of pressure difference or the like.

It is more preferable that the inner diameter of the transfer tube 3 be determined in such a manner that S₂ and S₃ satisfy the formulas (2) and (3), respectively. The degree of the angle S₃ varies depending upon the inner diameter d even if (i) the connection part of the transfer tube 3 and the vertical side wall lb has a fixed gradient value, (ii) the inside bottom section of the transfer tube 3 is downwardly bent or curved at a fixed position, and (iii) the inside bottom section of the transfer tube 3 is bent or curved by a fixed angle. As such, by determining the size of the inner diameter d in view of S₂ and S₃, it is possible to cause the polymer powder to flow smoothly.

“S₂=0” means that the transfer tube 3 is orthogonally connected to the vertical side wall 1b. Even in such events, by determining (i) the inner diameter of the transfer tube 3 and (ii) the position at which the inside bottom section of the transfer tube 3 is downwardly bent or curved, in such a manner that S₃ satisfies the formula (3), it is possible to cause the polymer powder to flow into the transfer tube 3 smoothly by the action of gravity.

The gas polymerization apparatus 100 of the present embodiment is configured so that the gas phase polymerization reactor 1 and the downstream gas phase polymerization reactor 9 are aligned in series so as to sandwich the gas separator 110. However, the present invention is not limited to the configuration which includes the downstream reactor 9 provided downstream of the separator 110. That is, the present invention may be configured so as to include the reactor 1 and the separator 110 only or alternatively may be configured so as to add another polymerization reactor downstream as in the present embodiment. The additional polymerization reactor can be configured in the same way as the polymerization reactor 1 and the downstream polymerization reactor 9, whereas the capacity, the number of material supply lines, the agitating manner, and the like may be determined as appropriate.

(Operation of Gas Phase Polymerization Apparatus 100)

Next, the following explains one example of a method for producing an olefin polymer by gas phase polymerization of an olefin carried out by use of the gas phase polymerization apparatus 100 of the present invention.

The method of the present invention is a method using the gas phase polymerization apparatus 100 of the present invention which includes a polymerization reactor 1; a gas separator 110; a transfer tube 3 connecting the reactor 1 and the separator 110. The method may include: a polymerization step of polymerizing an olefin in the reactor 1 in the presence of a first gas containing the olefin; a transfer step of transferring, into the separator 110 through the transfer tube 3, a mixture of the polymer powder and a second gas coexisting with the polymer powder in the reactor 1; a separation step of supplying a third gas into the separator 110 so as to replace, with the third gas, at least a part of the second gas contained in the mixture thus transferred into the separator 110 through the transfer step, thereby separating at least a part of the second gas from the polymer powder in the separator 110; and a discharge step of discharging the polymer powder through the outlet port 2b of the separator 110 after the separation step.

The polymerization step is a step of producing a polymer powder of an olefin by polymerizing the olefin (which is a main raw material) in the gas phase polymerization reactor 1 in the presence of a catalyst and an auxiliary material, such as hydrogen. The first gas is a mixture of the olefin and the auxiliary gas, such as hydrogen gas.

The transfer step is a step of introducing, into the gas separator 110 through the transfer tube 3, the polymer powder having been produced in the reactor 1, wherein the polymer powder is introduced together with the mixture gas (i.e., the second gas) of the olefin and the auxiliary gas. In a steady state of the continuous polymerization process, the first gas and the second gas have the same composition.

The separation step is a step of supplying, into the separator 110 through the replacement gas supply nozzle 4a, the replacement gas (i.e., the third gas) so as to replace the accompanying gas of the polymer powder in the separator 110 with replacement gas to a desired ratio. The accompanying gas which is separated from the polymer powder is returned to the reactor 1 through the transfer tube 3. This configuration eliminates the need for a device specially designed for purging or recycling the accompanying gas.

The discharge step is a step of intermittently discharging the polymer powder together with the accompanying gas present in the polymer powder, through the outlet port 2b of the separator 110.

The following explains one example of a concrete process of the method in accordance with the present invention for producing an olefin polymer.

First, the temperature and the pressure in the gas phase polymerization reactor 1 are set in accordance with a polymerization condition. Then, an olefin, which is the main raw material, and a catalyst are introduced, and then a polymerization reaction is performed. A molecular weight adjustment agent or an auxiliary material may be added in accordance with necessity. Examples of the molecular weight adjustment agent include hydrogen gas, whereas examples of the auxiliary material include an inert gas, such as nitrogen.

The polymerization pressure in the reactor 1 may be set in such a manner that the polymerization reaction can be proceeded. For example, when a downstream gas phase polymerization reactor 9 is provided, it is preferable that the polymerization pressure in the reactor 1 be set to a range higher than a pressure in the downstream polymerization reactor 9 by 0.2 Mpa to 1.0 Mpa. This is related to a capability of transferring the polymer powder from the separator 110 into the downstream polymerization reactor 9. In the present invention, the transfer of the polymer powder in the separation tank 2 is carried out by pneumatic transportation which uses the pressure difference between the separation tank 2 and the downstream reactor 9. The polymer powder to be transferred includes a gas primarily consisting of the replacement gas (typically, an olefin gas) which has been supplied into the separation tank 2. When the transferring of the polymer powder is occurred, the transfer capability is determined in accordance with, for example, the pressure difference; the size of the transfer tube; and the properties of the polymer or the gas which has been used. In view of easiness of transferring the polymer powder, it is preferable that the pressure difference between the upstream reactor 1 and the downstream reactor 9 be as great as possible. However, it is more preferable to keep the pressure in the upstream reactor 1 higher than that in the downstream reactor 9 by 0.2 Mpa to 1.0 Mpa so as not to make very large difference between the polymerization conditions in the reactors 1 and 9.

Polymerization conditions, such as a polymerization time, polymerization temperature, or the kinds of or the amounts of auxiliary materials, may be determined in accordance with a common knowledge of a person skilled in the art.

Subsequently, the polymer powder of olefin is fluidized in the reactor 1 by use of the circulating gas which is introduced through the circulating gas supply line 8. This advances the polymerization reaction further so as to produce polymer powder. The polymer powder thus obtained is transferred into the separation tank 2 through the transfer tube 3, and temporarily stored in the separation tank 2. At this time, the polymer powder is accompanied with a gas composed of a mixture of the olefin and the auxiliary material.

Furthermore, in the separation tank 2, the replacement gas is supplied through the replacement gas supply nozzle 4a so as to separate the accompanying gas of the polymer powder. This replaces the accompanying gas present in spaces contained in the polymer powder.

The linear velocity of the replacement gas flowing in the separation tank 2 may become greater than a terminal velocity of the polymer powder (i) when the replacement gas supply nozzle 4a is provided near the outlet port 2b or (ii) when the supply amount of the replacement gas is too great. This makes it unable to transfer the polymer powder through the outlet port 2b of the separation tank 2 because the polymer powder is blown back to the upstream reactor 1 by a flow of the supplied replacement gas. In order to avoid this, (i) a position at which the replacement gas supply nozzle 4a is provided or (ii) a flow volume of the replacement gas to be supplied through the replacement gas supply nozzle 4a may be controlled in such a manner that the linear velocity of the replacement gas flowing in the separation tank 2 will be less than the terminal velocity of the polymer powder in the separation tank 2.

When gas replacement has been carried out for a fixed time, the polymer powder thus subjected to the gas replacement is then discharged through the transfer tube 10 into the downstream reactor 9 by opening and closing of the discharge control valve 2c.

As the polymer powder is discharged, the surface level of the layer of the polymer powder in the separation tank 2 lowers. This causes a polymer powder having been produced in the reactor 1 to continuously flow down into the separation tank 2 by the action of gravity.

The above processes allow continuous production of a polymer in the gas phase polymerization apparatus 100.

### EXAMPLE

The present invention is explained with reference to examples below. However, it is to be noted that the present invention is not limited to these examples.

### Example 1

In Example 1, an apparatus including: an upstream gas phase polymerization reactor; a gas replacement tank; and a downstream gas phase polymerization reactor was provided, wherein the upstream polymerization reactor, the gas replacement tank, and the downstream polymerization reactor were serially connected with one another in this order. In the apparatus, production of polymer powder by continuous polymerization and intermittent transferring of the polymer powder were carried out. In Example 1, a transferring condition of the polymer powder and a gas replacement condition were studied. The upstream gas phase polymerization reactor, the gas replacement tank, and the downstream gas phase polymerization reactor were members corresponding to the gas phase polymerization reactor 1, the separation tank 2 of the gas separator 110, and the downstream gas phase polymerization reactor 9 of the embodiment described earlier, respectively.

In the present example, a gas replacement tank having a cylindrical shape was provided. The gas replacement tank had a total length which was 4.47 times greater than the inner diameter thereof. A lower part which corresponded to one fifth of the total length of the gas replacement tank had a conical shape, and S₁ in this case was 65.25°. Further, the gas replacement tank had an inlet port and an outlet port, the inlet port having an inner diameter which was equal to that of the body part of the gas replacement tank, whereas the outlet port having an inner diameter which was 0.13 times greater than that of the body part of the gas replacement tank.

The gas replacement tank had a wall surface provided with two replacement gas supply nozzles, wherein the two replacement gas supply nozzles were provided orthogonal to the wall surface. The two nozzles were provided at a position whose height from the outlet port of the gas replacement tank was 0.085 time greater than the total length of the gas replacement tank.

Then, the upstream gas phase polymerization reactor (hereinafter referred to as an “upstream reactor”) and the gas replacement tank were connected with each other via a transfer tube, and the gas replacement tank and the downstream gas phase polymerization reactor (hereinafter referred to as a “downstream reactor”), which was provided downstream of the gas replacement tank, were connected with each other via a pipe including a discharge control valve. The upstream reactor and the downstream reactor were different from each other in terms of a composition of a gas for use in the polymerization reaction.

Specifically, the transfer tube was connected to a transfer nozzle horizontally extending from an opening section in a vertical side wall of the upstream reactor (the opening section had an inner diameter which was equal to that of the body part of the replacement gas tank). In this case, the transfer tube had a part which was downwardly bent by 90°, so as to be connected to the gas replacement tank. A positional relation between the upstream reactor and the transfer tube was set in such a manner that S₂=0° and the angle S₃=39°.

In the upstream reactor, while a temperature of 80° C., a pressure of 1.75 MPaG, and a molar ratio of hydrogen to propylene (hereinafter referred to as H₂/C′₃) of 3.91 mol % were maintained, fluidization was sufficiently carried out by use of a gas flow having a linear speed of 0.17 m/a second. This produced, through polymerization reaction, polypropylene particles having an average particle diameter of 1200 μm, a bulk specific gravity of 0.45 g/cc, and an angle of repose of 35°. In the downstream reactor, on the other hand, while a temperature of 70° C. and a pressure of 1.3 MPaG were maintained, a fluidized condition was maintained by use of propylene, ethylene, and a hydrogen gas.

From the upstream reactor, (i) the polypropylene particles and (ii) a mixture gas of a hydrogen and propylene having an above composition were transferred into the gas replacement tank through the transfer tube. In the gas replacement tank, propylene was supplied, as the replacement gas, through the replacement gas supply nozzles in such a manner that supply amounts of propylene through the respective supply nozzles would be the same with each other and that the SG/PP ratio would be 0.023, wherein the SG/PP ratio was a ratio of (i) the weight of the propylene gas supplied through the two replacement gas supply nozzles in unit time to (ii) the weight of the polypropylene particles transferred from the gas replacement tank into the downstream reactor in unit time.

The opening time and the closing time of the discharge control valve were controlled so as to set the transfer condition of the polypropylene particles from the gas replacement tank in such a manner that the apparent volume of the polypropylene particles transferred from the gas replacement tank into the downstream reactor by one intermittent transfer was 1/1.34 times greater than the volume of the gas replacement tank (the apparent volume of the polypropylene was, in other words, the sum total of (i) the actual volume of the polypropylene particles discharged from the gas replacement tank and (ii) the volume of the gas present with the polypropylene particles).

In such conditions, the ratio of (i) the weight of hydrogen replaced with the propylene gas to (ii) the weight of the accompanying hydrogen transferred from the upstream reactor was 14%, and it was confirmed that gas replacement had been carried out (it is to be noted that the ratio is hereinafter referred to as a separation efficiency). Table 1 shows the H₂/C′₃ ratio in the upstream reactor, the SG/PP ratio, and the removal ratio.

TABLE 1

| | Examples | | | |
|---|---|---|---|---|
| | 1 | 2 | 3 | 4 |
| H₂/C′₃ Ratio in Upstream | 3.91 | 9.56 | 11.9 | 6.12 |
| Reactor (mol %) | | | | |
| SG/PP Ratio (—) | 0.023 | 0.026 | 0.034 | 0.083 |
| Separation Efficiency (%) | 14 | 24 | 54 | 87 |

In Example 1, S₁ was 65.25°, S₂ was 0°, S₃ was 39°, and θᵣ was 35°. These values were values satisfying all of the formulas (1) through (3).

### Examples 2 through 4

In each of Reference Examples 2 through 4, an experiment was carried out in a condition where the H₂/C′₃ ratio in the upstream reactor and the SG/PP ratio were varied from those in Example 1. Conditions other than the H₂/C′₃ ratio and the SG/PP ratio were the same as in Example 1. Table 1 shows a result obtained in and experiment conditions set in each of Examples 2 through 4.

As shown in the table, it is possible to adjust the separation efficiency of the accompanying gas to an arbitrary value by adjusting the SG/PP ratio.

<Stability in Continuous Operation of Polymerization Apparatus of Examples 1 through 4

In the polymerization apparatus including the gas replacement tank used in each of Examples 1 through 4, (i) a flow condition of polypropylene particles transferred from the upstream reactor into the gas replacement tank and (ii) a discharge condition of the polypropylene particles discharged from the gas replacement tank were good. Furthermore, the polymerization apparatus was continuously operated for 200 consecutive days in a condition that: the H₂/C′₃ ratio in the upstream reactor was set in a range from 0.03 to 12.0 mol %; and the SG/PP ratio in the gas replacement tank was set in a range from 0.022 to 0.083. When the gas replacement tank was opened after the continuous operation of the polymerization apparatus, there was neither adhesion of polymer powder particles to a wall surface nor a residual of aggregate of the polymer powder particles. No trouble such as clogging of the outlet port occurred during the continuous operation of the polymerization apparatus.

### Reference Example 1

In Reference Example 1, there was provided a polymerization apparatus which included a gas replacement tank configured in a way different from Example 1. In Reference Example 1, an experiment was carried out in such a manner that conditions other than the H₂/C′₃ ratio and the SG/PP ratio were the same as those in each of Examples.

The gas replacement tank used in Reference Example 1 had a cylindrical shape. The gas replacement tank had a total length which was 2.2 times greater than the inner diameter of the body of the gas replacement tank. Further, the gas replacement tank was divided into an upper chamber and a lower chamber by a gas distribution plate whose loss of pressure was 0.25 kPa. The gas distribution plate was set in such a manner that an angle formed between the gas distribution plate and a horizontal plane would be 45°.

The upper chamber provided above the gas distribution plate includes: an inlet port (whose inner diameter was 0.85 times greater than that of the body of the gas replacement tank) through which the polymer powder from the upstream reactor was introduced; and an outlet port (whose inner diameter was 0.05 times greater than that of the body of the gas replacement tank) through which the polymer powder was transferred from the gas replacement tank into the downstream reactor.

The inlet port for the polymer powder was provided at a top of the gas replacement tank. The outlet port for the polymer powder was provided at a position (i) at which the gas replacement tank and the gas distribution plate were in contact with each other and (ii) which was provided at a lowest part of the upper chamber provided above the gas distribution plate. An inlet port for a replacement gas (second gas) was provided below the gas distribution plate, so that the replacement gas supplied through the inlet port would pass through the gas distribution plate and uniformly distribute over an entire cross section of the gas replacement tank.

The opening time and the closing time of the discharge control valve were controlled so as to set a transfer condition of polypropylene particles in such a manner that the apparent volume of the polypropylene particles to be transferred by one intermittent transfer of the polypropylene particles from the gas replacement tank into the downstream reactor would be half the volume of the gas replacement tank (the apparent volume of the polypropylene particles was, in other words, the sum total of (i) the actual volume of the polypropylene particles to be extracted from the gas replacement tank and (ii) a volume of the gas being present with the polypropylene particles). When the experiment was carried out in a condition where it was further set that the H₂/C′₃ ratio in the upstream reactor was 7.42 and the SG/PP ratio was 0.027, the separation efficiency was 19 %. Table 2 shows the H₂/C′₃ ratio, the SG/PP ratio, and the dissociation efficiency in the upstream reactor in Reference Example 1.

TABLE 2

| | Reference Examples | | | |
|---|---|---|---|---|
| | 1 | 2 | 3 | 4 |
| H₂/C′₃ Ratio in Upstream | 7.42 | 8.44 | 9.75 | 11.1 |
| Reactor (mol %) | | | | |
| SG/PP Ratio (—) | 0.027 | 0.030 | 0.038 | 0.062 |
| Separation Efficiency (%) | 19 | 23 | 53 | 70 |

In Reference Example 1, S₂ was 0°, whereas S₃ was 39°, thereby satisfying the formulas (2) and (3), respectively.

As a result, it was found that though the gas replacement efficiency in Reference Example 1 was neither superior nor inferior to that in Example 1, clogging of the outlet port occurred in Reference Example 1.

### Reference Examples 2 through 4

Next, in each of Reference Examples 2 through 4, an experiment was carried out in a condition where an H₂/C′₃ ratio in an upstream reactor and the SG/PP ratio were varied from those in Reference Example 1. In each of Reference Examples 2 through 4, conditions other than the H₂/C′₃ ratio and the SG/PP ratio were the same as in Reference Example 1. Table 2 shows a result obtained in and experiment conditions set in each of Reference Examples 2 though 4.

As a result, it was found that though a gas replacement efficiency in each of Reference Examples 2 through 4 was neither superior nor inferior to the gas replacement efficiency in each of Examples 2 through 4, clogging of the outlet port occurred in each of Reference Examples 2 through 4.

<Stability in Continuous Operation of Polymerization Apparatus Used in Reference Examples 1 through 4>

Next, continuous operation of the polymerization apparatus used in each of Reference Examples 1 through 4 was carried out in a condition where: the H₂/C′₃ ratio in the upstream reactor was set in a range from 0.38 to 13.6 mol %; and the SG/PP ratio in the gas replacement tank was set in a range from 0.026 to 0.131.

As a result, continuous operation of the polymerization apparatus was able to be stably carried out for a range from 1 day (minimum) to merely 30 consecutive days (maximum), due to formation of a polymer aggregate in the gas replacement tank. With the polymerization apparatus, while the gas accompanying the polymer powder was able to be replaced in an arbitrary ratio, it was impossible to operate the apparatus continuously for a long time period.

The gas phase polymerization apparatus of the present invention can be used in producing polyolefin, such as polypropylene, and polyethylene, because it is capable of improving the production efficiency of an polymer and capable of being continuously operated for a long time.

The present invention is not limited to the description of the embodiments above, but may be altered by a skilled person within the scope of the claims. An embodiment based on a proper combination of technical means disclosed in different embodiments is encompassed in the technical scope of the present invention.

1. A gas phase polymerization apparatus, comprising:
a gas phase polymerization reactor;
a gas separator into which a mixture of a polymer powder and a gas is introduced; and
a transfer tube connecting the reactor and the separator,
the separator having: an inlet port through which the mixture is introduced; a replacement gas inlet through which a replacement gas is introduced; an outlet port through which the polymer powder is discharged; and a tank in which the gas contained in the mixture is replaced with the replacement gas, the tank having a columnar shape having one end section which is configured in a conical shape whose cross sectional area decreases toward a tip of the section, and
the outlet port being provided at the tip of the conically-shaped section of the tank.

2. The gas phase polymerization apparatus as set forth in claim 1, wherein the transfer tube is always opened.

3. The gas phase polymerization apparatus as set forth in claim 1, wherein
when the longitudinal direction of the tank of the separator coincides with the vertical direction, a relationship represented by the following formula (1) is satisfied:
θᵣ≦S₁<90° (1)
where S₁ is the degree of an angle formed between (i) a slope of the conically-shaped section of the tank and (ii) the horizontal plane, and θᵣ is the degree of an angle of repose of the polymer powder.

4. The gas phase polymerization apparatus as set forth in claim 1, wherein
when the longitudinal direction of the tank of the separator coincides with the vertical direction, a relationship represented by the following formula is satisfied:
30°≦S₁<90°
where S₁ is the degree of an angle formed between (i) a slope of the conically-shaped section of the tank and (ii) the horizontal plane.

5. The gas phase polymerization apparatus as set forth in claim 1, wherein
when the longitudinal direction of the tank of the separator coincides with the vertical direction:
the transfer tube is connected to a vertical side wall of the polymerization reactor at one end of the tube, and to the gas separator at the other end; and wherein a relationship represented by the following formula (2) is satisfied:
0°≦S₂≦90° (2)
where S₂ is the degree of an angle formed between (a) a straight line that is tangential to an inner wall surface of the transfer tube and passes a lowermost point of a connection section of the transfer tube and the vertical side wall and (b) a plane orthogonal to a surface of the vertical side wall; and a relationship represented by the following formula (3) is satisfied:
θᵣ≦S₃≦90° (3)
where S₃ is the degree of an angle formed between (c) a straight line that is tangential to the inner wall surface of the transfer tube at the lowest tangential point and that passes an uppermost point of the connection section and (d) the plane orthogonal to the surface of the vertical side wall, and θᵣ is the degree of an angle of repose of the polymer powder.

6. A method for producing an olefin polymer by use of the gas phase polymerization apparatus as set forth in claim 1, the gas phase polymerization apparatus including the polymerization reactor, the gas separator, and the transfer tube connecting the reactor and the separator,
the method comprising:
a polymerization step of polymerizing an olefin in the reactor in the presence of a first gas containing the olefin to produce a powder of a polymer of the olefin;
a transfer step of transferring, from the reactor into the separator through the transfer tube, a mixture of (a) the polymer powder and (b) a second gas which coexists with the polymer powder in the reactor;
a separation step of supplying a third gas into the separator so as to replace, with the third gas, at least a part of the second gas contained in the mixture transferred into the separator through the transfer step, thereby separating at least a part of the second gas from
